(19) United States
(12) Patent Application Publication
(10) Pub. No.: US 2024/0078472 A1
(43) Pub. Date: Mar. 7, 2024

(54) Method for Determining Training Data for Training a Model, in particular for Solving a Recognition Task

(71) Applicant: Robert Bosch GmbH, Stuttgart (DE)

(72) Inventors: Christian Haase-Schuetz, Fellbach (DE); Heinz Hertlein, Erlenbach (DE); Joscha Liedtke, Besigheim (DE); Oliver Rogalla, Vaihingen (DE)

(21) Appl. No.: 18/461,577

(22) Filed: Sep. 6, 2023

(30) Foreign Application Priority Data
Sep. 7, 2022 (DE) 10 2022 209 282.1

(51) Int. Cl. G06N 20/00

(52) U.S. Cl. CPC G06N 20/00

(57) ABSTRACT

An iterative method is for determining training data for a primary model to solve a primary recognition task. The iterative method includes a) providing at least one labeled training sample, b) training the primary model with the at least one labeled training sample, c) providing at least one labeled test sample, and d) evaluating a recognition performance of the primary model using the labeled test sample on the primary recognition task. The iterative method further includes, depending on a result of the evaluating the recognition performance, either (i) re-performing parts a), b), c), and d) of the iterative method, or (ii) ending the iterative method.

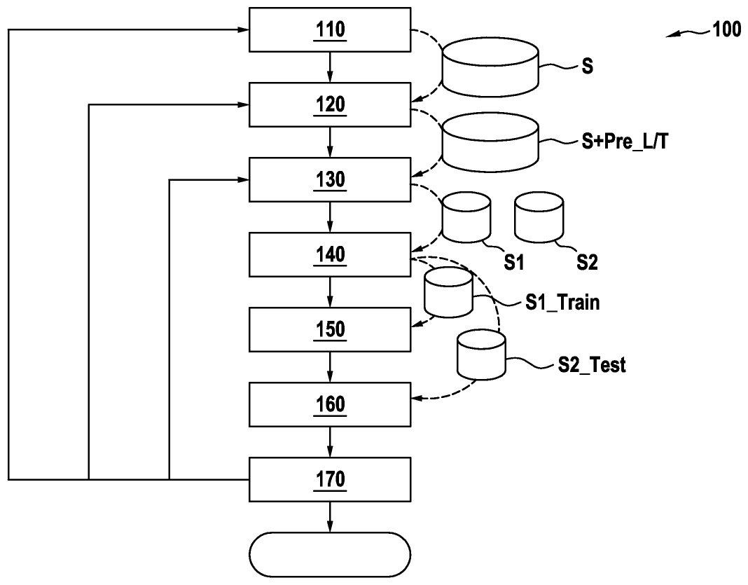

This application claims priority under 35 U.S.C. § 119 to patent application no. DE 10 2022 209 282.1, filed on Sep. 7, 2022 in Germany, the disclosure of which is incorporated herein by reference in its entirety.

### BACKGROUND

One important problem in the field of robotics is environmental perception. This involves sensing the environment of an autonomous or semi-autonomous, or automated or semi-automated operating machine with sensors and recognizing it with pattern recognition methods, therefore converting the sensor data into a symbolic description of relevant aspects of the environment. This symbolic description then forms the basis for performing actions in the environment corresponding to the application or intended use of the machine. A typical example of symbolic representation of the environment is to describe static and dynamic objects using attributes that, for example, characterize the location, shape, size, speed, and so forth, of the respective object. The attributes that show the symbolic representation are referred to as the label. For example, the objects can be obstacles with which a collision must be avoided.

Often, this environmental perception is based on the data provided by a single sensor or a combination of multiple sensors. Processing this sensor data to generate the symbolic representation of the environment presents a complex problem of pattern recognition. The best recognition performance, i.e. the smallest probability of failure, is usually achieved using trained methods, in particular artificial Deep Neural Networks, whose architecture has a greater number of hidden layers.

In order to be able to train such methods, a labeled sample is required consisting of recorded sensor measurements and the associated labels, i.e. the symbolic description of the objects recognized by the sensor. For the achievable recognition performance, i.e. the accuracy, reliability and general validity of the trained model resulting from the training material, the size of the training sample as well as the statistical distribution of the sensor data contained therein is of essential importance. For general validity, it is particularly important that all conditions relevant for the respective application, which can affect properties of the sensor data, are sufficiently represented in the training data. This presents a particular challenge because the plurality of relevant conditions is initially not fully known and because some conditions are comparatively rare, also known as the “long tail problem”.

### SUMMARY

One embodiment relates to a method for determining training data for a primary model, in particular for solving a primary recognition task, the method comprising an iterative process with at least the following steps: providing at least one labeled training sample; training the primary model with the labeled training sample; providing at least one labeled test sample; evaluating a recognition performance of the primary model using the labeled test sample on the primary recognition task; and depending on the result of the evaluation of the recognition performance, either a) re-performing steps of the iterative process or b) ending the iterative process.

A primary model is understood to mean a model that is to be trained to solve a primary recognition task. The primary recognition task is thus the task to be solved with a trainable model, here the primary model. In the context of the environmental perception of a robot, the goal of the primary recognition task is, for example, to generate a symbolic description of the objects in the environment of the robot.

A sample is understood in each case as an amount of data in the context of the present invention. A sample can generally be used as training data to train the primary model. A sample comprises multiple samples. This is, for example, real measurement data, for example, sensed sensor data. In the method according to the invention, the samples are available in a respective processing step in a correspondingly processable format in each case. The samples can be subjected to corresponding data processing steps. Such processing steps are not further explained in the context of the present invention.

For example, the provision of the labeled training sample and/or the labeled test sample is done based on an initially unlabeled sample.

In contrast to existing solutions, the iterative method described herein is based on constructing a training sample, at least partially manually labeled, by means of a selection of unlabeled samples, which maximizes the recognition performance of the trained model compared to a different selected training amount of the same size. In order to maximize the proportion between the recognition performance of the model and the size of the labeled training sample, the recognition performance of the iteratively optimized model is continuously evaluated during the method so that selection of further training data can be made based on an analysis of this recognition performance.

Thus, a significant element of the method is the evaluation of the recognition result of the trained primary model on a test sample. Based on the results of this evaluation, weaknesses of the model can be identified. Suitable additional training material can be selected or procured. In addition, evidence of the accuracy, reliability, and/or general validity of the primary model can be provided.

According to one embodiment, the method comprises: Provision of an unlabeled sample. An unlabeled sample, for example, is understood to mean an amount of unlabeled data that could generally be used to generate training data to train the primary model. Such unlabeled data is based on, for example, real measurement data, for example, recognized sensor data. According to an example of the present invention, sensor data are recorded during measurement runs with a vehicle equipped with at least one corresponding sensor or sensor set, on whose sensor data the model to be optimized is configured. Sensor data are typically recorded along with time stamps and stored on a non-volatile data storage medium. All of the recorded sensor data can be referred to as unlabeled samples.

According to one embodiment, the method further comprises: Generating pre-labels for the unlabeled sample, in particular by means of the primary model, and/or generating tags, in particular by means of a secondary model, for the unlabeled sample.

For example, generating pre-labels or tags occurs automatically with one or more models, for example, with models trained from training data, and/or other algorithms. If at least one model is used, it can be the primary model itself or a model which solves the primary recognition task to be optimized by the iterative method. However, it can also be a further model, here a secondary model, which solves a further secondary recognition task. For example, a secondary recognition task can comprise characterizing weather conditions or incorporating other environmental parameters.

If this is the primary model, or a model that solves the primary recognition task, the labels generated therefrom are referred to as pre-labels. This is the same type of label that is created by manual labeling in a subsequent step of the method.

If this is the secondary model that solves the secondary recognition task, the labels generated therefrom are referred to as tags. Tags represent a symbolic description of these conditions that can affect the primary recognition task.

Alternatively and/or additionally, the generation of pre-labels and/or tags can be done manually.

According to one embodiment, the method further comprises: Evaluating the pre-label and/or tags and, based on the evaluation of the pre-label and/or tags, selecting a first partial sample to generate a labeled training sample and selecting a further partial sample to generate a labeled test sample.

After the, in particular automatic, generation of pre-labels and/or tags, an, in particular automatic, evaluation of pre-labels and/or tags is carried out. The aim of this automated evaluation is to define a sample that represents a portion of the unlabeled sample and that can be used to improve the model. The sample defined in this way is referred to as a partial sample.

It is advantageous when the first and further partial samples are disjunctive. The selection and composition of training and test samples can be done with the same parameters. However, it can also be advantageous if the selection and composition of the training and test samples are performed with different parameters.

According to one embodiment, the method further comprises: Generating a labeled training sample based on the first partial sample and generating a labeled test sample based on the further partial sample. By generating labels, labels are generated for the partial samples selected in the previous step. These labels represent a type of symbolic description that corresponds to the primary recognition problem. According to an example of the present disclosure, this can be references to a location and/or other attributes of the objects in the environment of a vehicle. It can prove advantageous if the labeling is done manually.

It can advantageously be provided that the generation of labels for the first partial sample and/or the further partial sample is carried out based on pre-labels, in particular as a function of a pre-label confidence. The manual labeling process can be made simpler, faster, and/or less expensive with the same or better resulting recognition accuracy and/or reliability by utilizing the automatically generated pre-labels of the primary recognition problem generated in step 120. For example, the manual labeling process can proceed such that the existing pre-labels are reviewed and corrected or supplemented only as necessary. Alternatively and/or additionally, the manual label process can be improved and/or can be designed more cost-effectively by including confidences of the pre-labels that have been automatically generated by the model. For example, the pre-labels whose confidence value exceeds a certain threshold value can be accepted as reference label without manual review.

According to one embodiment, it is provided that re-performing steps of the iterative process as a function of the result of evaluating the recognition performance comprises at least one or more of the following steps: a) providing an unlabeled sample, b) generating pre-labels and/or tags for the unlabeled sample, c) evaluating the pre-labels and/or tags, and based on evaluating the pre-label and/or tags, selecting a first partial sample to generate a labeled training sample and selecting a further partial sample to generate a labeled test sample, d) generating a labeled training sample based on the first partial sample and generating a labeled test sample based on the further sample.

In accordance with one embodiment, it is provided that the evaluation of the recognition performance of the primary model is based on metrics for characterizing reliability and/or accuracy of the primary recognition task of the primary model.

Another embodiment relates to using training data determined according to a described method to train the primary model, in particular to solve the primary recognition task.

Further features, possible applications and advantages of the invention are shown in the following description of embodiment examples of the invention, which are shown in the FIGURE of the drawing. All described or depicted features by themselves or in any combination constitute the subject matter of the invention, regardless of their consolidation in the claims or their antecedent reference, as well as regardless of their formulation or representation in the description or in the drawing.

### BRIEF DESCRIPTION OF THE DRAWING

The FIGURE shows steps of a method for determining training data for a model in accordance with one embodiment.

### DETAILED DESCRIPTION

In the FIGURE, schematic steps of a method for determining training data for a model according to one exemplary embodiment are shown.

The method is explained by way of an example from the field of robotics, environmental perception. This involves sensing the environment of an autonomous or semi-autonomous, or automated or semi-automated operating machine with sensors and recognizing it with pattern recognition methods, i.e. converting the sensor data into a symbolic description of relevant aspects of the environment. This symbolic description then forms the basis for performing actions in the environment corresponding to the application or intended use of the machine. For example, the machine can be an autonomous or semi-autonomous vehicle, or more generally, a robot acting autonomously or semi-autonomously. A typical example of symbolic representation of the environment is to describe static and dynamic objects using attributes that, for example, characterize the location, shape, size and speed of the respective object. The attributes that show the symbolic representation can be referred to as the label. For example, the objects can be obstacles with which a collision must be avoided.

Often, this environmental perception is based on, in particular, digital image data of an image sensor, in particular a video, radar, LiDAR, ultrasonic, motion or thermal image sensor, or a combination of multiple such sensors. For example, multiple sensors can be combined into a multimodal sensor set.

Processing such sensor data to generate the symbolic representation of the environment presents a complex problem of pattern recognition. The best recognition performance, i.e. the smallest probability of failure, is usually achieved using trained methods, in particular artificial Deep Neural Networks, whose architecture has a greater number of hidden layers.

In order to be able to train such methods, a labeled sample is required consisting of recorded sensor data and the associated labels, i.e. the symbolic description of the objects recognized by the sensor. For the achievable recognition performance, i.e. the accuracy, reliability and general validity of the trained model resulting from the training material, the size of the training sample as well as the statistical distribution of the sensor data contained therein is of essential importance. For general validity, it is particularly important that all conditions relevant for the respective application, which can affect properties of the sensor data, are sufficiently represented in the training data.

The following explains a method comprising an iterative process that can be used to improve training data for a trained/trainable model and thus improve the model itself.

In the following detailed description of the method 100, the recognition task to be solved with a trainable model, here a primary model, is referred to as the primary recognition task. In the context of the environmental perception of a robot, the goal of the primary recognition task is, for example, to generate a symbolic description of the objects in the environment of the robot.

The method 100 comprises a step 110 for providing an unlabeled sample S.

An unlabeled sample, for example, is understood to mean an amount of unlabeled data that could generally be used to generate training data to train the primary model. Such unlabeled data is based on, for example, real measurement data, for example, recognized sensor data. According to an example of the present invention, sensor data are recorded during measurement runs with a vehicle equipped with at least one corresponding sensor or sensor set, on whose sensor data the model to be optimized is configured. Sensor data are typically recorded along with time stamps and stored on a non-volatile data storage medium. All of the recorded sensor data can be referred to as unlabeled samples.

According to one embodiment, the acquisition of sensor data can occur, for example, during the development of a machine, in particular a vehicle, by means of a prototype. The prototype is equipped with, for example, the sensor or the sensor set, which is also used later in the series machine, for example series vehicles. It can prove advantageous if additional reference data are acquired. For example, at least one further sensor, in this case referred to as a reference sensor, can be used for this purpose. The reference data can be used to improve and/or simplify a generation of pre-labels and/or tags in a subsequent step of the method. Thus, there can be a reduction in effort and/or cost due to the use of a reference sensor. The reference sensor can enable a higher quality of the reference data compared to the sensors of the series machine, for example, the series vehicle. For example, the reference data can enable a higher resolution and/or higher accuracy and/or higher reliability and/or better range and/or larger field of view. Alternatively and/or additionally, the reference data can have the advantage over the series machine sensor data of providing a model with which the tags and/or pre-labels can be automatically recognized and transferred to the series machine data, or such a model can provide a higher quality of automatically generated tags and/or pre-labels compared to the quality of the results of a model for the series sensor data.

According to one embodiment, the acquisition of sensor data can occur, for example, during the application of a machine, in particular a vehicle, by means of a series machine, for example a series vehicle. For example, the sensor data can be uploaded to a central server computer and/or to a cloud infrastructure via a wireless communication link for persistent storage and further processing. In this case, the method can be used to continuously further develop environmental perception and/or to further develop and/or validate functions, such as driving functions, which are already in use by an end user and/or which are enabled after validation.

Method 100 comprises a step 120 for generating pre-labels Pre_L for the unlabeled sample S, in particular by means of the primary model, and/or generating tags T, in particular by means of a secondary model, for the unlabeled sample S. The generation of pre-labels and/or tags is performed, for example, automatically using one or more models, for example, models trained using training data, and/or other algorithms. Alternatively and/or additionally, the creation of pre-labels and/or tags can also be done manually.

If at least one model is used, it can be the primary model itself or a model which solves the primary recognition task to be optimized by the iterative method. However, it can also be a further model, here a secondary model, which solves a further secondary recognition task. For example, a secondary recognition task can comprise characterizing conditions, such as environmental conditions, that can impact the primary recognition task, such as weather conditions, but also other environmental parameters.

If the primary model, or a model that solves the primary recognition task, is used, the labels generated therefrom are referred to as pre-labels. This is the same type of labels that are created by manual labeling in a subsequent step of the method. Manually created labels can have a higher accuracy and/or reliability than the pre-label. However, the accuracy of the automatically generated pre-labels can improve in the course of the method, i.e. from iteration to iteration of the method, so that the accuracy of the pre-labels approaches the accuracy of the manual labels more and more closely.

The primary model for generating pre-labels can be the trained model of the previous iteration of the method. It can also be an offline variant of the primary model. For example, when using deep learning models, a network architecture that employs a larger number of layers and/or a larger number of neurons per layer can be used for the offline variant. This larger offline model can be trained in each iteration in addition to an online model using the same training sample. The training is explained in relation to a subsequent step of the method. Alternatively and/or additionally, the offline variant can also perform processing of the sensor data forwards and backwards in time and/or smoothing and/or a plausibility check of the generated pre-labels over time to improve accuracy and/or reliability.

Particularly in the first iteration of the method, in which a primary model is not yet available from the previous iteration, the use of a pre-trained model can be useful, for example one that originates from another application, but also solves the primary recognition task. Alternatively, in the first iteration, the pre-labels can also be generated in the form of manual labels in step 120.

Examples of labels, including pre-labels, manually generated labels, or automatically generated labels, are static and dynamic objects in the environment of the machine, for example the vehicle. Examples of static objects include guardrails, lane markings, lane boundaries, roadside construction, and warning beacons. Examples of dynamic objects include other vehicles, cyclists, and pedestrians.

If a secondary model is used in step 120, the labels generated therefrom are referred to as tags. The secondary model solves a secondary recognition task. For example, a secondary recognition task can comprise characterizing conditions, such as environmental conditions, that can impact the primary recognition task, such as weather conditions, but also other environmental parameters. Such conditions can impact the primary recognition task in that the recognition accuracy and/or reliability of the primary recognition task can change as a function of these conditions.

Tags represent a symbolic description of these conditions that can affect the primary recognition task.

Examples of such conditions and corresponding tags include: a) tags which describe weather conditions for example, “sunny,” “cloudy”, “rainy,” “snowfall”, b) time of day dependent tags, for example, “day,” “dusk”, “night” c) tags that describe properties of the road, for example, “dry road”, “wet road”, “snow on the road”, d) tags that describe the type of road, for example “town,” “country road”, “highway”, “one-way road”, “single lane road”, “two-lane road”, e) tags that describe properties of traffic, for example, “low traffic density”, “high traffic density”, “slow-moving traffic”, “congestion,” f) tags that describe the properties of objects of the primary recognition problem, such as the type of vehicle or the distance of a vehicle to the ego vehicle.

For example, some of these tags can be automatically generated from labels and/or pre-labels of the primary recognition issue. In one example, a metric can be defined that corresponds to the traffic density by determining the number of objects in a particular region around the machine, for example the vehicle. For example, this metric can be automatically calculated from pre-labels.

The method 100 comprises a step 130 for evaluating the pre-label Pre_L and/or tags T and based on the evaluation of the pre-label Pre_L and/or tags T selecting a first partial sample S1 to generate a labeled training sample S1_Train and selecting a further partial sample S2 to generate a labeled test sample S2_Test.

The evaluation is advantageously carried out automatically. A sample defined by the automated evaluation is referred to as a partial sample or a partial sample of a respective iteration. One aim of the automated evaluation is to define at least one first partial sample, which represents a portion of the unlabeled sample and which can be used to improve the primary model in training. The training sample is advantageously selected such that the training sample is suitable for training the primary model for at least one particular use, such as a particular function of a machine, for example a driving function of an autonomous or semi-autonomous vehicle, so that the primary model can be accurately and efficiently trained with the training sample.

A further sample is further defined, which can be used in a subsequent step as a test sample to evaluate the trained primary model.

It is advantageous when the first and further partial samples are disjunctive. The selection and composition of training and test samples need not necessarily be done with the same parameters.

For example, evaluating and selecting samples of the sample for the partial sample can comprise the following steps and/or be based on the following conditions:
a) When evaluating, for example, a similarity of individual samples of the sample to each other can be taken into account. A plurality of samples that have a comparatively high similarity to each other can be reduced to a smaller portion of this plurality of samples or a single sample. For example, an amount of samples that have been included at short time intervals can be reduced so that no more than one sample is included in the partial sample at a given time interval, since samples included at short time intervals usually have high similarity or correlation to each other. Clustering methods can be used to define portions, also called clusters, of similar samples. Each cluster can be reduced to a sample or a comparatively low number of samples typical for the particular cluster. To assess the similarity of two samples, distance measures between samples can be defined. These distance measures can be based on the sample data itself. These distance measures can also be based on pre-labels and/or tags of the samples. If the distance measures are based on the samples, methods such as a Principal Component Analysis (PCA) or other methods for feature calculation or low-dimensional representation of the samples are used to improve the properties or informative value of resulting distance measures.
b) When evaluating, pre-labels and/or tags can be considered to select samples that are relevant for training the primary model. For example, depending on pre-labels, samples in which there is a high probability that there is no object relevant for the primary recognition task can be filtered out. These samples are not used in the partial sample. In another example, in which the primary model is trained for a function, for example a driving function, which can only be activated in a particular environment, for example outside closed locations, samples can be filtered based on corresponding tags. Thus, for example, samples that have not been recorded in the particular environment, for example, in the interior location, can be filtered out. These samples are not used in the partial sample.

Filtering out non-relevant samples can improve the efficiency of a subsequent label operation of the method and thus reduce effort and costs.
c) When evaluating, pre-labels and/or tags can be considered to map a desired proportion of conditions in the partial sample. For example, it can be advantageous that relevant conditions in a partial sample occur in certain, for example, similar, proportions, in particular with regard to a number of samples of the partial sample. Requirements of the application in which the primary model is to be used can also be included.
d) When evaluating, correlations between metrics that characterize recognition accuracy and/or reliability of the primary recognition problem can be considered in connection with relevant tags. For example, these metrics can be determined for the trained primary model of the previous iteration based on the test sample of the previous iteration and/or further test samples for which the ground truth label is present. One example is the correlation of metrics of the primary recognition task with tags that characterize the weather situation. In this case, for example, if the recognition performance in rain is not sufficient, then samples recorded in rain can be filtered and selected based on the tags.
e) During evaluation, continuous and/or modified metrics of the primary recognition task can be determined or considered. Such metrics even allow for an assessment of recognition accuracy and/or reliability of recognition when other metrics, such as metrics that are directly relevant to the function being implemented or meet the specific requirements of the function, do not allow such an assessment due to a limited size of the test sample. As an example, the accuracy of an object localization can be considered. The function to be implemented, for example an autonomous or semi-autonomous driving function, can define a requirement for the recognition accuracy of the object localization. This requirement can be derived from a safety requirement, for example. For example, it can be required that the deviation of the positional accuracy of the objects localized by the trained model for relevant objects does not exceed a particular threshold ϑ₁. Especially in an advanced stage of optimization, it is necessary that only a small proportion of the samples in the test sample have an overshoot of the threshold value ϑ₁, or that no single sample has an overshoot of this type. For this reason, the determination of the accuracy and/or reliability of the trained primary model is not possible or not possible with sufficient statistical certainty when solely considering the threshold value ϑ₁. Instead, in the example considered herein, an additional threshold ϑ₂ can be considered that is less than the threshold ϑ₁ and thus represents a more demanding requirement for the trained primary model. A similar example is to consider a continuous metric rather than a binary, for example threshold-based, metric, for example the average deviation of the position rather than the proportion of deviations from the position exceeding a threshold.
f) When evaluating a multimodal sensor set, either the recognition performance of multiple, in particular all, sensors of the multimodal sensor set can be considered together or the recognition performance of the sensors individually. The consideration of individual sensors can be particularly useful if the function to be implemented is based on the multimodal sensor set. The consideration of individual sensors can be useful if the evaluation of the metrics of the multimodal sensor set relevant to the function is not possible with sufficient statistical certainty alone. This is the case, for example, if strict requirements for the quality of the recognition system are derived from the safety requirements of the system. However, as this high quality, i.e. recognition accuracy and/or reliability of environmental perception, typically increases due to the combination of sensor data from multiple independent sensors, it can be useful to consider the quality of recognition when using the sensors individually.

When selecting the first partial sample to generate a labeled training sample and selecting the further partial sample to generate a labeled test sample, in particular in a respective iteration, the following relationships are advantageously considered:

With the size of the partial sample, i.e. the number of samples per partial sample, the effort to generate labels increases. At the same time, with a larger partial sample, a greater improvement in the recognition performance of the primary recognition task can be achieved.

The size of a respective partial sample can also vary across the iterations of method 100. Iterations with smaller partial samples and correspondingly smaller increases in recognition performance per iteration require a greater number of iterations on the one hand to achieve a desired recognition performance. On the other hand, iterations with smaller partial samples require fewer resources and thus less time and cost per iteration.

Method 100 comprises a step 140 of generating a labeled training sample S1_Train based on the first partial sample S1 and generating a labeled test sample S2_Test based on the further sample S2.

In this step, the partial samples defined in step 130 are labeled so that reference labels are available for all samples selected in step 130. These labels represent the symbolic description corresponding to the primary recognition problem. These can be, for example, references to the location and/or other attributes of the objects in the environment of the machine, for example, the vehicle.

Label generation is advantageously done manually, or at least in part manually.

The manual labeling process can be made simpler, faster, and/or less expensive with the same or better resulting recognition accuracy and/or reliability by utilizing the automatically generated pre-labels of the primary recognition problem generated in step 120. For example, the manual labeling process can proceed such that the existing pre-labels are reviewed and corrected or supplemented only as necessary.

Alternatively and/or additionally, the manual label process can be improved and/or can be designed more cost-effectively by including confidences of the pre-labels that have been automatically generated by the model. For example, the pre-labels whose confidence value exceeds a certain threshold value can be accepted as a reference label without manual review.

Method 100 comprises a step 150 of training the primary model with the labeled training sample S1_Train.

Training samples are used to monitor training of the primary model for the primary recognition task. It can be provided that the training samples available from previous iterations of the method during training also are included. Alternatively, if a trained primary model of the primary recognition task is already present, for example, from the second iteration of the method, re-training (adaption) of the pre-existing primary model can be performed without incorporating the labeled training samples from previous iterations, as they have already been incorporated into the existing primary model. This can reduce training effort compared to a “from scratch” training, where the weightings are re-initialized at the beginning of the training and all training samples from the current and previous iterations are used.

Optionally, the training can also be carried out in such a way that samples that have not been labeled in step 140, i.e. which are not part of a training sample, are also included in the training by using the automatically generated pre-label for these samples. The impact of the typically less accurate and/or reliable pre-label can be reduced by including weighting in the training process and weighting the non-manually labeled samples lower. This can improve the result of the training because the training amount is then typically much larger overall compared to using only the samples training sample with manual labels.

Method 100 comprises a step 160 of evaluating a recognition performance of the primary model using labeled test sample S2_Test on the primary recognition task. In this step, the trained primary model resulting from step 150 is evaluated using the test sample.

The evaluation is performed, for example, using metrics to characterize reliability and/or accuracy of the primary recognition task.

The evaluation can also be based on the test sample of the current iteration in combination with at least one test sample from at least one previous iteration or all test samples from previous iterations. This has the advantage that the evaluation is based on an overall greater amount of samples and the resulting metrics typically have a higher accuracy.

Different metrics can be considered for the evaluation, with which the classification performance of the model in particular can be determined. For example, one or more of the following metrics can be used: a) Intersection over Union (IoU), b) calculating pairs comprising precision and recall, the calculation can be made dependent on a threshold, which is compared to the confidence of the model prediction, for example, to identify objects considered valid, c) Average Precision (AP) for calculating a mean value of the precision over the range of values of the threshold value d) mean Average Precision (mAP) for calculating the mean value of the Average Precision over all classes.

One or more metrics can be selected depending on the primary recognition problem and/or at least one sensor used or sensors in the multimodal sensor set.

It can be advantageously provided that a correlation between tags and at least one of these metrics is determined. This correlation can advantageously be used in step 130 in a subsequent iteration of the method.

In a step 170 of the method 100, depending on the result of the evaluation of the recognition performance, it is determined whether either a) steps of the iterative process are performed again or b) the iterative process is terminated.

For example, based on the metrics determined in step 160, a decision can be made as to whether the reliability and/or accuracy of the model is sufficient or whether further iterations of steps of method 100 are performed. For example, thresholds can be defined for the metrics against which this decision is made. These threshold values can be derived, for example, from requirements for the function to be implemented, in particular the driving function.

For example, the next iteration of method 100 can begin in step 110 or step 120 or step 130. It can be provided that it is determined or can be determined at which step the next iteration begins.

For example, depending on the result of the evaluation from step 160, it can also be determined whether the next iteration of the method begins in step 110 or step 120 or step 130.

For example, from the result of evaluating from step 160 in step 170, it can be inferred that the recognition performance of the primary model is not yet sufficient in certain situations and/or conditions, and that these situations and/or conditions are not present in the samples of the pre-existing labeled samples, nor in the unlabeled samples. In this case, it can be determined to begin the next iteration of method 100 at step 110 so that a new unlabeled sample is specifically provided, for example by recording sensor data in the particular situations and/or under the particular conditions. After step 110 has been performed, the iteration is continued with steps 120, 130, 140, 150, 160 and 170.

Alternatively, the method can also be continued after step 170 with the next iteration in step 120. This is advantageous, for example, if the provision of a new unlabeled sample is deemed unnecessary and/or the embodiment of method 100 does not provide for the recapturing and recording additional sensor data, for example, for practical reasons and/or for cost reasons. Starting the next iteration at step 120 can be useful if pre-labels and/or tags are generated using the trained primary model available from the previous iteration. Due to the expected improvement of the trained primary model from iteration to iteration, in this case an improvement of the quality of the pre-labels and/or tags generated and thus also an improvement of the evaluation and filtering or selection of the first and the further partial samples in step 130 can be expected.

Alternatively, to continuing the method 100 after step 170 with the next iteration in step 110 or 120, the method with the next iteration in step 130 can also take place. This can be advantageous to reduce the effort required to automatically generate pre-labels and/or tags for a typically large amount of unlabeled data occurring in step 120. It can be provided that the automatic generation in step 120 is performed only once in the method, or multiple times in the method in each iteration, or not in each iteration. For example, step 120 can be performed at every nth iteration, wherein n can be determined.

What is claimed is:

1. An iterative method for determining training data for a primary model to solve a primary recognition task, the iterative method comprising:
a) providing at least one labeled training sample;
b) training the primary model with the at least one labeled training sample;
c) providing at least one labeled test sample;
d) evaluating a recognition performance of the primary model using the labeled test sample on the primary recognition task; and
depending on a result of the evaluating the recognition performance either (i) re-performing parts a), b), c), and d) of the iterative method, or (ii) ending the iterative method.

2. The iterative method according to claim 1, further comprising:
providing an unlabeled sample.

3. The iterative method according to claim 2, further comprising:
generating pre-labels for the unlabeled sample using the primary model; and/or
generating tags using a secondary model for the unlabeled sample.

4. The iterative method according to claim 3, further comprising:
evaluating the pre-labels and/or the tags; and
based on the evaluation of the pre-labels and/or the tags, selecting a first partial sample to generate a labeled training sample of the at least one labeled training sample and selecting a further partial sample to generate another labeled test sample of the at least one labeled training sample.

5. The iterative method according to claim 4, wherein:
at least one of the following elements is considered when evaluating:
a) a similarity of individual samples of a sample,
b) a relevance of samples for training the primary model,
c) a proportion of conditions in the first and the other partial sample,
d) correlations between metrics, which characterize a recognition accuracy and/or reliability of the primary recognition task and/or correlations between metrics, which characterize a recognition accuracy and/or reliability of the primary recognition task, and tags,
e) continuous and/or modified metrics of the primary recognition task, and
f) a recognition performance of certain sensors.

6. The iterative method according to claim 4, further comprising:
generating the labeled training sample based on the first partial sample; and
generating the other labeled test sample based on the further partial sample.

7. The iterative method according to claim 6, wherein the generating labels is performed for the first partial sample and/or the further partial sample based on pre-labels as a function of a confidence of the pre-label.

8. The iterative method according to claim 1, wherein re-performing parts of the iterative method as a function of the result of evaluating the recognition performance comprises:
a) providing an unlabeled sample,
b) generating pre-labels and/or tags for the unlabeled sample,
c) evaluating the pre-labels and/or tags, and based on the evaluating, selecting a first partial sample to generate a labeled training sample of the at least one labeled training sample and selecting a further partial sample to generate another labeled test sample of the at least one labeled training sample,
d) generating the labeled training sample based on the first partial sample and generating the other labeled test sample based on the further sample.

9. The iterative method according to claim 1, wherein the evaluation of the recognition performance of the primary model is based on metrics for characterizing reliability and/or accuracy of the primary recognition task of the primary model.

10. The iterative method according to claim 1, further comprising:
using the training data determined according to the iterative method to train the primary model to solve the primary recognition task.
